(19) United States
(12) Patent Application Publication
(10) Pub. No.: US 2021/0179864 A1
(43) Pub. Date: Jun. 17, 2021

(54) Fire Resistant Compositions, Coatings, and Related Methods and Building Assemblies

(71) Applicant: Gardner-Gibson, Inc., Tampa, FL (US)

(72) Inventors: Amir Khan, Lutz, FL (US); Prabani Dissanayake, Wesley Chapel, FL (US); Stephanie Meyers, Tampa, FL (US)

(21) Appl. No.: 17/121,026

(22) Filed: Dec. 14, 2020

Related U.S. Application Data
(60) Provisional application No. 62/947,256, filed on Dec. 12, 2019.

(51) Int. Cl. C09D 5/18; C09D 125/14; C09D 133/06; C09D 7/61; E04B 1/94; E04D 12/00; E04D 7/00; B05D 3/00; B05D 7/06

(52) U.S. Cl. CPC C09D 5/185; C09D 125/14; C09D 133/062; C09D 7/61; B05D 7/06; E04D 12/002; E04D 7/00; B05D 3/007; E04B 1/942

(57) ABSTRACT

The invention as disclosed herein includes a composition for increasing the fire resistance of a substrate. The composition is composed of a solvent; a polymer binder; a carbon-based flame retardant; a fire retardant compound, such as a phosphorous based flame retardant compound or a char forming flame retardant; a heat absorbing compound; and a phyllosilicate material. Also included are methods of reducing the flammability of a substrate or of increasing the fire resistance of a substrate by applying the composition of the invention, wherein the inflammability of the substrate is improved when compared to an identical substrate that is not coated with the composition. Fire resistant coatings prepared from the composition of the invention are disclosed. The assemblies described herein exhibit improved fire resistance as compared to an identical assembly that does not include the coating.

### CROSS REFERENCE TO RELATED APPLICATIONS

This application claims the benefit under 35 U.S.C. § 119(e) of U.S. Provisional Patent Application No. 62/947,256, filed Dec. 12, 2019, the entire disclosure of which is incorporated herein by reference.

### BACKGROUND OF THE INVENTION

Building structures, particularly roof decks, are often constructed from useful and economical materials such as fiberboard, plywood and oriented strand board. These materials are, however, flammable. Use of such materials in building, especially residential dwellings, can be dangerous since, once exposed to a flame, they permit rapid spread of the flames and bringing elements throughout the structure.

To address this disadvantage, numerous fire-resistant compositions have been developed to reduce the flammability and/or the rate of speed that these materials burn. While some of the prior art fire-resistant compositions have met a level of success, they are expensive and/or create challenges and delay during installation. Alternatively, non or less flammable additions such as densdeck (chalk, limestone) are used in the structure. This is an added layer, which adds cost and is not a fool proof guarantee from flammability.

There remains a need in the art for a fire-resistant composition that exhibits superior fire resistance and is easy to apply/install.

### BRIEF SUMMARY OF THE INVENTION

The invention as disclosed herein includes a composition for increasing the fire resistance of a substrate. Advantageously, it can also function as a primer. It may also be used as a bleed-blocker, preventing oils and such from exuding to the surface and causing incompatibility and discoloration, thereby eliminating at least one step in the manufacture of a roof assembly, potentially reducing costs and person-hours needed for overall roof installation.

The composition is composed of a solvent; a polymer binder; a carbon-based flame retardant; a fire retardant compound, such as a phosphorous based flame retardant compound or a char forming flame retardant; a heat absorbing compound; and a phyllosilicate material. The composition may also include as asphalt, preferably provided in the form of an asphalt emulsion.

Also included are methods of reducing the flammability of a substrate or of increasing the fire resistance of a substrate by applying the composition of the invention, wherein the inflammability of the substrate is improved when compared to an identical substrate that is not coated with the composition.

Fire resistant coatings prepared from the composition of the invention are disclosed, as are roofing assemblies that include a roof deck to which is affixed a first underlayment having a lower surface that is adjacent to an upper surface of the roof deck and an upper surface; and the coating, where a lower surface of the coating is adjacent to the upper surface of the underlayment. The assemblies described herein exhibit improved fire resistance as compared to an identical assembly that does not include the coating. Such improvements may be evaluated by application of the “Burning Brand” test method of ASTM E108-17 and/or the “Spread of Flame” test method of ASTM E108-17.

### DETAILED DESCRIPTION OF THE INVENTION

Described herein are compositions and coatings that may be used to improve, enhance and increase the fire resistance of a substrate and various methods related to such composition. The composition as described herein may be used “neat” as a coating or primer; it may also be formulated to be or used as an additive in a paint, adhesive, film forming formulation or other formulation that can be applied to a substrate to improve, enhance and increase its fire resistance.

The compositions and methods described herein provide improved fire resistance of the substrate to which they are applied as compared to an identical substrate to which the composition of the invention has not be applied. Such improvement may range from incremental to significant.

While an end use specifically contemplated for the invention is to increase the fire resistance of roof decks, “substrate” as used herein may include virtually any material for any end use. Use in virtually any aspect of building construction (e.g., any part or portion of a building, dwelling or shelter) is contemplated. Also included are uses of the invention to treat articles, elements, and components used in the areas of aviation, institutions (e,g., schools, prisons, hospitals), automotive, industrial, marine, household goods, furnishings, furniture, textile, clothing, etc.

Substrates may therefore include, for example, wood, metal, concrete, stone, brick, plywood, pressboard, oriented strand board, fiberboard, sheet rock, stucco, polymers, a wall treatment, an automotive part, an aviation part, and fiberglass. The composition maybe applied to, for example, textiles (woven and non-woven, carpets), fibers, skins (tanned or untanned), leathers and suedes (vegan or animal), foams, paper and cardboard.

“Fire resistance” as used herein means the ability of the substrate to resist flame burn through and/or to resist the development of flying burning material as a function of time. Evaluation of fire resistance may be carried out by any means known or to be developed. For example, in the case where the substrate is a roof deck, fire resistance may be evaluated using the test methods set forth in ASTM E108-17 for “Standard test Methods for Fire Tests of Roof Coverings”, published March 2017, as is relevant for the context.

The composition of the invention includes a solvent that is preferably non-flammable, a polymer binder, a carbon-based flame retardant, a fire retardant phosphorous containing compound, a heat absorbing compound, a phyllosilicate, and a mineral based filler. Optionally an asphalt, preferably in the form of an asphalt emulsion, may be included. This embodiment may be utilized to provide extra level of adhesion to substrate if needed or desired.

The solvent for use in the invention may be any known or to be developed in the art. Water or water-based solvents are of course suitable.

While any amount may be used, it may be preferred that the solvent is present in the composition in an amount of about 20% to about 60%, about 30% to about 50%, or about 35% to about 45% by weight of the composition overall.

The polymer binder may be any known or developed in the art if the selected polymer is sufficiently resistant to fire in the context of the overall composition (i.e., it does not make the end composition less inflammable). As used herein, the term “polymer” includes copolymers (two or more different monomers copolymerized to one another) as well as large molecules composed of the same monomer polymerized together, unless specifically noted.

Exemplary polymer binders may include latex, vinyl acetate-ethylene polymer, a styrene polymer, an acrylic polymer, a water-based epoxy polymer, a methacrylic polymer, a water-based urethane, a polyvinyl acetate, a styrene-butadiene polymer, any copolymers of these, and any mixtures thereof.

Also included may be polymer binders that are a vinyl acetate-ethylene copolymer, a styrene acrylic copolymer, aqueous acrylic dispersions or a mixture of two or of all three of these polymers. Such binders may be obtained commercially, for example, from BASF, 450 Clark Drive, Budd Lake, N.J., United States (sold under, for example, the ACRONAL line of products). Mixtures or blends of one or more polymer binder(s) from any source may be used.

The polymer binder can be used in any amount. However, in several embodiments one may prefer to include the polymer binder in an amount of about 5% to about 50%, about 53% solids.

The composition further includes a carbon-based flame retardant. Suitable options include, for example, graphene, expandable graphite, carbon fibers, carbon nanotubes, and carbon nanotube-polymer nanocomposites. Mixtures of various types of carbon-based flame retardants may also be used.

When included in the composition of the invention, it may be preferred that the carbon-based flame retardant(s) are included in an amount of about 1% to about 7%, about 2% to about 3% or about 2.5% by weight of the composition overall, without limitation.

A flame-retardant compound or mixture of the same is incorporated into the composition of the invention. Such compounds may be, for example, halogenated or melamine based-flame retardants, and phosphorus containing compounds.

In an embodiment, it may be preferred that the flame-retardant compound or mixture is or includes a flame-retardant phosphorus containing compound(s). Such compound may be any known or to be developed in the art. Suitable examples may be, without limitation, aryl phosphates, chlorophosphates, di-phosphates, 9,10-dihydro-9-oxa-10-phosphaphenanthrene-10-oxide (DOPO), 5,5-dimethyl-[1,3,2]dioxaphosphinane-2-oxide (DDPO), DOPO- or DDPO-based compounds, phosphinates, phosphine oxides, alkyl phosphate oligomers, Red-Phosphorous, trialkylphosphates, ammonium polyphosphonate, organic phosphate esters, inorganic phosphorus containing salts, and ammonium polyphosphate. Mixtures of two or more phosphorus containing compounds are also contemplated. Melamine polyphosphate, available from, for example, THOR Industries, Wincham Avenue, Northwich, Cheshire, United Kingdom, under the trade name TLP 1630, may be used in some embodiments.

The flame-retardant phosphorus containing compound may be included in the inventive composition in any amount. In some embodiments one may prefer that it is included in an amount of about 3% to about 15%, about 5% to about 10%, or about 6% to about 8.5% by weight of the composition overall.

In embodiments, a heat absorbing compound (i.e., an endothermic flame retardant) is included in the composition of the invention. Such compounds are those inorganic materials known or to be developed that decompose endothermically under flame with the release of inert gases and/or water vapor to provide a potential fire-retardant effect. In practice suitable materials are, for example, group II or III carbonates or hydroxides, aluminum trihydrate, magnesium hydroxide, brucite, huntite Mg₃Ca(CO₃)₄, hydromagnesite, boron compounds, antimony oxide, aluminum hydroxide, molybdenum compounds and/or zinc borate. Mixtures of any heat absorbing compound may also be used.

Overall, one may prefer that the heat absorbing compound(s) are included in an amount of about 1% to about 25%, about 3% to about 8%, and about 5% to about 7% by weight of the total composition.

A phyllosilicate material is included in the composition of the invention. Such may be, for example, colloidal clays, smecitite, kalonite, illite, alumino-silicate, montmorillonite; polymer-clay nanocomposites, Bermuda slurry and bentonite clay. Mixtures of any phyllosilicate materials may be used. One may include the selected phyllosilicate material in a suspension or dispersion, for example, a 5, 6, 7, 8, 9, or 10% suspension. The phyllosilicate material may be present in any amount; exemplary amounts of the suspension/dispersion that are included in the composition may be about 10% to about 50%, about 15% to about 40% by weight and about 25% to about 35% by weight of the total composition.

One may include an adhesion promoter in the composition. It may be about 0.1%-1% by weight.

Mineral based filler may optionally be included in the composition; in some embodiments, a mixture of two, three or more mineral based fillers may be preferred. Exemplary fillers include calcium- and/or silicate-based fillers. Specific examples include without limitation talc, glass, glass powder, glass spheres, limestone, hydrated lime, dolomites, silicates, silica gel, fumed silica, fused silica, nanosilica, pozzolan, fly ash, chalk (calcium carbonate), and mixtures thereof. In an embodiment one may prefer a mineral based filler that is a mixture of glass spheres, limestone and talc. Used in the composition, exemplary amounts may include about 5% to about 30%, about 10% to about 25%, about 15% to about 20% by weight of the total composition.

Optionally, an asphalt may be included in the composition. The asphalt may be of any type, for example, flux or types 1, 2, 3, 4 or a hard penetration asphalt. The asphalt is preferably delivered to the composition in the form of an asphalt emulsion, such emulsion including at least asphalt, water and an emulsifying agent, such as a surfactant, a colloidal clay or a poly(styrene-butadiene-styrene copolymer. If present, the asphalt may be present in the asphalt emulsion in amounts of about 0.01% to about 10% by weight of the total composition. The asphalt emulsion that may be provided to the composition in amounts of about 0.3% to about 5%, about 0.7% to about 2% and about 1% by weight (in emulsion form) of the total composition.

In some embodiments, other additives may be included in the composition. Additives may be, without limitation, one or more of a biocide, a mildewcide, a fungicide; a bactericide; an algaecide, a pigment, a colorant, a UV absorbing compound, a fragrance, a particulate, a texturing material, a reflectant, a visible light absorbing compound, a pearlescent, an antioxidant, a surfactant, a solvent, rheology modifier, a defoamer, and/or water.

The composition may be prepared by any means. In an embodiment, it is prepared by mixing or grinding all ingredients in the desired amounts together until thoroughly mixed.

The invention includes methods of reducing the inflammability of a substrate and of increasing the fire resistance of a substrate. Such methods include providing a substrate as described above and applying the composition to a surface of the substrate. After application the composition is permitted to dry/cure. Such drying/curing may occur in the ambient environment, or heat, air, or light may be applied. The substrate may be a vertical surface (e.g., a wall of a room) or a horizontal surface (e.g., a floor of a room).

Application of the composition to the substrate may be carried out by any means known or developed. Suitable methods may include wiping, painting, spraying, dipping, rolling and/or brushing.

The quantity of “reduction” or “improvement” provided by the composition as compared to identical but untreated substrates may be evaluated by any suitable empirical means (which may vary depending on the substrate). If, for example, the substrate is a roof deck, one may use the methods set forth in ASTM E108-17 as applicable.

Also within the scope of the invention are coatings that are formed on the substrate after application of the above-described coating to the substrate. In an embodiment, the coating is peelably removable from the substrate, so it can be re-positioned on another surface. The coating may be distributed on the substrate in any volume. In some embodiments, it is preferred that the coating is present in an amount of about 1 gallon to about 5 gallons per square yard or about 2.5 gallons per square yard to about 4 gallons per square yard.

Alternatively, the coating may be present in an amount of about 1 gallon to about 5 gallons per square meter or about 2.5 gallons per square meter to about 4 gallons per square meter.

All components discussed herein may be “mixed and matched” with one another in any permutation to arrive at the composition or coating of the invention.

Roof deck assemblies that include the coatings of the invention are also contemplated. Such assemblies include, for example, a roof deck having an upper surface. The roof deck may be of, for example, plywood or oriented strand board.

The roof deck's upper surface is adjacent to a lower surface of an underlayment. The underlayment also has an upper surface, which may bear a texture, such as a fleeced texture. The underlayment is affixed to the roof deck. The composition of the invention is applied to the upper surface of the underlayment to form a coating. Optionally, the upper surface of the coating may be itself coated with an elastomeric coating.

The assembly exhibits improved fire resistance as compared to an identical assembly that does not include the coating. Such improvement may be determined by use of the “Burning Brand” test method of ASTM E108-17 or the “Spread of Flame” test method of ASTM E108-17.

### Example 1—Preparation of an Exemplary Composition of the Invention

The ingredients of Table 1 are placed in a mixer/grinder in the amounts set forth in Table 1. Mechanical mixing/grinding is applied until the mixture is uniform.

TABLE 1

| | Amount (weight percent | Tolerance |
|---|---|---|
| Component | of total composition) | (%) |
| Asphalt emulsion | 1.0 | 0-15 |
| Water | 25 | 20-60 |
| Talc * (median diameter of | 6 | 2-10 |
| 4.8 microns) | | |
| Polymer binder | 31 | 50 |
| (ACRONAL ® NX3587) ** | | |
| Expandable graphite | 2.5 | 1-10 |
| Aluminum trihydrate | 10 | 2-15 |
| Bermuda Slurry (dispersion | 17 | 2-35 |
| in water) | | |
| Melamine polyphosphate | 8.5 | 2-20 |
| Bactericide | 0.1 | 0.1-1 |
| Adhesion Promoter (Momentive | 0.5 | 0.1-1 |
| A-1120) | | |
| TOTAL | 100 | |

* Talc was NICRON ® 403 from Imery Performance Additives, Paris, France.
** Vinavil ® 4735 is a propriety product of MAPEI Corp., East Newport Center Drive, Deerfield Beach, FL, USA and is described by BASF a styrene- acrylic dispersion.

Properties of the exemplary composition are shown in Table 2.

TABLE 2

| Property | |
|---|---|
| % Weight Solids | 40-50% |
| % Weight Water | 40-60% |
| Weight VOC | <25 g/L |

### Example 2—Evaluation of Composition by “Burning Brand” Test Method

The composition of example 1 was evaluated using the “Burning Brand” test method set out in ASTM E108-17, at pages 6-8.

The sample test decks were prepared as directed by ASTM E108-17. Each deck was made of plywood of 15×32 inches and about 0.5 inches thick. See, id. at pages 2-5.

First, a self-adhered membrane was applied to the deck surface (Weather Armor FT). Second, the composition of example 1 was applied in an amount of 2.5 gallons per square yard of surface area. Finally, a white elastomeric roof coating was applied, also in an amount of 2.5 gallons per square yard of surface area. No coverboard or insulation was applied (this is optional to the ASTM; absence of the insulation and coverboard is a “worst case scenario” situation, so any “pass” results achieved without these elements indicates a “pass” if they were present).

The deck was set up at a 2-inch incline per foot.

A brand burning at greater than 1700 degrees F. was applied to the deck as directed by the ASTM. To pass, the ASTM dictates that the brand must not burn through the deck after 90 minutes of burning.

The test system was left to burn until it extinguished itself after 30 minutes. The flame never reached the deck itself.

### Example 3—Evaluation of Composition by “Spread of Flame” Test Method

The composition of example 1 was evaluated using the “Spread of Flame” test method set out in ASTM E108-17, at page 6.

The decks as described and coated above in example 2 were used. The test was carried out as set forth in ASTM E108. The test method involves a flame at 12 miles per hour and a temperature of greater than 1700 degrees F. igniting the deck which is positioned at an incline dictated by the ASTM. To pass this test, the flame cannot travel 6 feet in 10 minutes nor can it “drip” off the deck edge.

The decks treated with the composition of the invention passed, as the flame was only able to travel 2.5 feet in 10 minutes.

### Example 4—Preparation of an Exemplary Composition of the Invention

The ingredients of Table 3 are placed in a mixer/grinder in the amounts set forth in Table 3. Mechanical mixing/grinding is applied until the mixture is uniform.

TABLE 3

| | Amount (weight percent | Tolerance |
|---|---|---|
| Component | of total composition) | (%) |
| Water | 42 | 20-60 |
| Melamine | 2.5 | 2-10 |
| Pentaerythritol | 2.5 | 1-10 |
| Polymer binder | 21 | 5-50 |
| (ACRONAL ® NX3587) ** | | |
| Expandable graphite | 3.5 | 1-10 |
| Aluminum trihydrate | 4.5 | 2-15 |
| Zinc Borate | 5 | 2-15 |
| Bentonite clay | 8 | 2-35 |
| Melamine polyphosphate | 8.7 | 2-20 |
| Bactericide | 0.1 | 0.1-1 |
| Adhesion Promoter (Momentive | 2.6 | 0.1-10 |
| A-1120) | | |
| TOTAL | 100 | |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A composition for increasing the fire resistance of a substrate comprising:
a. A solvent;
b. A polymer binder;
c. A carbon-based flame retardant;
d. A fire retardant compound;
e. A heat absorbing compound; and
f. A phyllosilicate material;

2. The composition of claim 1, further comprising an asphalt.

3. The composition of claim 1, further comprising a mineral based filler.

4. The composition of claim 1, wherein the fire retardant compound is selected from a phosphorous containing compound and a N-based char forming compound.

5. The composition of claim 1, wherein the solvent is water.

6. The composition of claim 1, wherein the polymer binder is selected from latex, vinyl acetate-ethylene polymer, a styrene polymer, an acrylic polymer, a water-based epoxy polymer, a methacrylic polymer, a water-based urethane, a polyvinyl acetate, a styrene-butadiene polymer, any copolymers of these, and any mixtures thereof.

7. The composition of claim 1, wherein the polymer binder is selected from a vinyl acetate-ethylene copolymer, a styrene acrylic copolymer and mixtures thereof.

8. The composition of claim 1, wherein carbon-based flame retardant is selected from graphene, expandable graphite, carbon fibers, carbon nanotube and mixtures thereof.

9. The composition of any of claims 1 to 2, wherein the fire retardant compound is selected from melamine phosphates, aryl phosphates, chlorophosphates, di-phosphates, DOPO, DDPO, DOPO- or DDPO-based compounds, phosphinates, phosphine oxides, alkyl phosphate oligomers, Red-Phosphorous, trialkylphosphates, ammonium polyphosphonate, organic phosphate esters, and inorganic phosphorus containing salts, and mixtures thereof.

10. The composition of claim 1, wherein the fire retardant compound is selected from one of melamine polyphosphate, nitrogen, and pentaerythritol.

11. The composition of claim 1, wherein the heat absorbing compound is selected from aluminum trihydrate, magnesium hydroxide, brucite, huntite, hydromagnesite, a group II carbonate, a group II hydroxide, a group III carbonate, a group III hydroxide, boron compounds, antimony oxide, aluminum hydroxide, molybdenum compounds, zinc borate, and mixtures thereof.

12. The composition of claim 1, wherein the heat absorbing compound is aluminum trihydrate.

13. The composition of any of claim 1, wherein the phyllosilicate material is selected from smecitite, kalonite, illite, alumino-silicate, montmorillonite, polymer-clay nanocomposites, Bermuda slurry, bentonite clay, and mixtures thereof.

14. The composition of claim 1, wherein the phyllosilicate material is Bermuda slurry.

15. The composition of claim 3, wherein the mineral based filler is selected from talc, glass, glass powder, glass spheres, limestone, hydrated lime, dolomites, silicates, silica gel, fumed silica, fused silica, nanosilica, pozzolan, fly ash, chalk (calcium carbonate), and mixtures thereof.

16. The composition of claim 3, wherein the mineral based filler is talc.

17. The composition of claim 2, wherein the asphalt is in the form of an asphalt emulsion.

18. The composition of claim 17 wherein an emulsifier of the asphalt emulsion is selected from a colloidal clay, a poly(styrene-butadiene-styrene) copolymer and mixtures thereof.

19. The composition of claim 1, further comprising a biocide, a mildewcide, a fungicide; a bactericide; an algaecide; and mixtures thereof.

20. The composition of claim 1 further comprising a colorant, a UV absorbing compound, a fragrance, a particulate, a texturing material, a reflectant, rheology modifier, a defoamer, a visible light absorbing compound, an antioxidant, and mixtures thereof.

21. A method of reducing the inflammability of a substrate comprising
a. Providing a substrate;
b. Coating the substrate with the composition of claim 1,
wherein the inflammability of the substrate is improved when compared to an identical substrate that is not coated with the composition.

22. The method of claim 21 further including the step of drying or curing the coating.

23. The method of claim 21 wherein the substrate includes a vertical surface.

24. The method of claim 21 wherein the substrate includes a horizontal surface.

25. The method of claim 21 wherein the substrate includes an inclined surface.

26. The method of claim 21, wherein the substrate is a roof deck.

27. The method of claim 21, wherein the substrate comprises wood, plywood, pressboard, fiberboard, sheet rock, stucco, metal, polymer, a wall treatment, an automotive part, an aviation part, and fiberglass.

28. The method of claim 21, wherein the substrate is a textile, a fiber and/or a tanned animal skin.

29. The method of claim 21, wherein the substrate is a foam.

30. The method of claim 21 wherein the coating step is accomplished by a method that comprise at least one of wiping, painting, spraying, dipping, rolling and brushing.

31. A method increasing the fire resistance of a substrate comprising
a. Providing a substrate;
b. Coating the substrate with the composition of claim 1,
wherein the fire resistance of the substrate is improved when compared to an identical substrate that is not coated with the composition.

32. The method of claim 31, further including the step of drying or curing the coating.

33. The method of claim 31, wherein the substrate includes a vertical surface.

34. The method of claim 31, wherein the substrate includes a horizontal surface.

35. The method of claim 31, wherein the substrate includes an inclined surface.

36. The method of claim 31, wherein the substrate is a roof deck.

37. The method of claim 31, wherein the substrate comprises wood, plywood, pressboard, fiberboard, sheet rock, oriented strand board, stucco, tile, metal, polymer, a wall treatment, a automotive part, an aviation part, and fiberglass.

38. The method of claim 31, wherein the substrate is a textile, a fiber and/or a tanned animal skin.

39. The method of claim 31, wherein the substrate is a foam.

40. The method of claim 31, wherein the coating step is accomplished by a method that comprise at least one of wiping, painting, spraying, dipping, rolling and brushing.

41. A fire-resistant coating that is formed by the curing or drying of the composition of claim 1.

42. The coating of claim 41, wherein the coating is formed on a substrate.

43. The coating of claim 41 wherein the coating is peelably removable from the substrate.

44. The coating of claim 41 present in an amount of about 1 gallon per square yard to about 2.5 gallons per square yard.

45. A roofing assembly comprising:
a. a roof deck to which is affixed a first underlayment having a lower surface that is adjacent to an upper surface of the roof deck and an upper surface; and
b. the coating of claim 39, wherein a lower surface of the coating is adjacent to the upper surface of the underlayment.

46. The assembly of claim 45 further comprising an elastomeric top layer that is adjacent to an upper surface of the coating.

47. The assembly of claim 45, wherein the upper surface of the underlayment bears a texture.

48. The assembly of claim 47, wherein the texture is a fleece texture.

49. The assembly of claim 45 wherein the roof deck is made of a material selected from plywood, wood, oriented strand board and press board.

50. The assembly of claim 45 having improved fire resistance as compared to an identical assembly that does not include the coating.

51. The assembly of claim 50 wherein the improved fire resistance is evaluated using the “Burning Brand” test method of ASTM E108-17.

52. The assembly of claim 50 wherein the improved fire resistance is evaluated using the “Spread of Flame” test method of ASTM E108-17.
